(19) United States
(12) Patent Application Publication
(10) Pub. No.: US 2010/0304078 A1
(43) Pub. Date: Dec. 2, 2010

(54) FIRE RESISTANT SYSTEMS, METHODS AND APPARATUS

(75) Inventors: Israel Stol, Pittsburgh, PA (US); Robert J. Speer, Upper Burrell, PA (US); Jean Ann Skiles, Gibsonia, PA (US); Paula L. Kolek, Tarentum, PA (US); Roger W. Kaufold, Pittsburgh, PA (US); James T. Burg, Verona, PA (US); Lori A. Barrage, Natrona Heights, PA (US); Brett Page Conner, Allison Park, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 12/791,745

(22) Filed: Jun. 1, 2010

Related U.S. Application Data
(60) Provisional application No. 61/182,987, filed on Jun. 1, 2009.

(51) Int. Cl. B32B 5/00; G01N 19/10

(52) U.S. Cl. 428/98; 428/220; 156/60; 73/29.02

(57) ABSTRACT

The present disclosure relates to fire-resistant systems, methods, and apparatus. In one embodiment, a fire-resistant system includes a fire-resistant panel and a protected material coupled to the fire-resistant panel. The fire-resistant panel includes a passive layer and a back layer. The passive layer comprises a phyllosilicate material. The back layer comprises an inorganic material and may be coupled to the passive layer. Optionally, the fire-resistant panel may include a secondary layer comprising a functional material, where the functional material comprises one of a phase change material or an endothermic material.

### CROSS-REFERENCE TO RELATED APPLICATION

This application claims priority to U.S. Patent Application No. 61/182,987, filed Jun. 1, 2009, entitled “FIRE RESISTANT SYSTEMS, METHODS, AND APPARATUS,” which is incorporated herein by reference in its entirety. This application is also related to PCT Patent Application No. PCT/US2010/036933, filed Jun. 1, 2010, entitled “FIRE RESISTANT SYSTEMS, METHODS, AND APPARATUS”, which is incorporated herein by reference in its entirety.

### BACKGROUND

Fire resistance and fume resistance are required for many applications, including for military equipment, as well as residential apartment and commercial buildings. Two materials that are commonly used to restrict the spreading of fire are intumescent paints and hard coatings. While intumescent paints absorb energy and delay spreading of fire, the charring of the carbon in the paint results in smoke or fumes when the carbon combines with oxygen in the air. Hard coatings provide a ceramic type barrier to withstand high temperatures and do not char, but ceramic materials may be brittle and may have a high weight.

### SUMMARY OF THE DISCLOSURE

The present disclosure relates to fire-resistant systems, methods, and apparatus. In particular, the present disclosure relates to fire-resistant systems, methods, and apparatus that may have modular capability, are lightweight, and have a high fire resistance. In one aspect, a fire-resistant system includes a fire-resistant panel and a protected material, which is coupled to the fire-resistant panel. The fire-resistant panel includes a passive layer comprising a phyllosilicate material and a back layer comprising an inorganic material and coupled to the passive layer.

The fire-resistant panel may have multiple properties to facilitate high fire resistance and a lightweight fire-resistant system. In one embodiment, the fire-resistant panel is configured to facilitate portability and modular application of the fire-resistant panel. Modular means a fire-resistant panel that is flexible, portable and can be used in a variety of ways. For example, fire-resistant panels that are modular are easy to handle, transport and apply to a protected material. In one embodiment, a plurality of panels may be interconnected. In one embodiment, the fire-resistant panel has a flame spread index of not greater than about 25 when tested in accordance with ASTM E-84. In one embodiment, the fire-resistant panel has a smoke developed index of not greater than about 50 when tested in accordance with ASTM E-84. In one embodiment, the fire-resistant panel has a thickness of not greater than about 1.3 inches. In one embodiment, the fire-resistant panel has a density of not greater than about 2 g/cm³.

As noted above, the fire-resistant panel includes a passive layer, which may further facilitate high fire resistance, lightweight, and modular capability of the fire-resistant system. In one embodiment, the passive layer comprises a front face (F). In one embodiment, the passive layer has a melting point of at least about 600° C. In one embodiment, the passive layer has a sintering temperature of at least about 1000° C. In one embodiment, the passive layer has a bulk density of not greater than about 1.6 g/cm³. In one embodiment, the passive layer has a thermal conductivity of not greater than about 1 W/(m*K). In one embodiment, the passive layer has a specific heat capacity of at least about 0.8 kJ/kg*K. In one embodiment, the passive layer has a compressive strength of at least about 1.0 MPa. In one embodiment, the passive layer has a porosity of at least about 85%. In one embodiment, the passive layer has a coefficient of thermal expansion of not greater than about 15×10⁻⁶ K. In one embodiment, the passive layer has a thickness of at least about 6 mm.

As noted above, the fire-resistant panel includes a back layer, which may further facilitate high fire resistance, lightweight, and modular capability of the fire-resistant system. In one embodiment, the back layer has a melting point of at least about 600° C. In one embodiment, the back layer has a thermal conductivity of not greater than about 0.025 W/mK at about 25° C. In one embodiment, the back layer has a bulk density of not greater than about 4.0 g/cm³. In one embodiment, the back layer has a maximum use temperature of not greater than about 650° C. In one embodiment, the back layer has a thickness of not greater than about 6 mm.

To further facilitate high fire resistance, the fire-resistant panel may include a secondary layer. The secondary layer may comprise a functional material. The functional material may comprise one of a phase change material or an endothermic material. In one embodiment, the phase change material is copper. In one embodiment, the endothermic material is at least one of sodium bi-carbonate (NaHCO₃) and aluminum-tri-hydrate (ATH). In one embodiment, the passive layer comprises a recessed portion and the functional material is at least partially located in the recessed portion. In one embodiment, the recessed portion has a depth in the range from about 1/16 inch to about 5/16 inch. In one embodiment, the functional material is proximal the passive layer via a supporting member coupled to the passive layer. The supporting member may be one of a metallic, inorganic or organic material. In one embodiment, the functional material is proximal the passive layer via impregnation of the functional material with the passive layer.

To further facilitate high fire resistance and structural integrity to the fire-resistant panel, the fire-resistant panel may include a wrap comprising at least one of aluminum foil, metal foil, and amorphous silica fabric. In one embodiment, the fire-resistant panel is encased within the wrap.

To further facilitate high fire resistance, the fire-resistant panel may include at least one spacer comprising at least one of aluminum feedstock, aluminum expanded metal, and vermiculite. In one embodiment, the at least one spacer is a protrusion of the passive layer. In some embodiments, the at least one spacer is one of shims, dimples on the aluminum foil, blocks, or bars. In one embodiment, the at least one spacer is from about 1 mm to about 5 mm in diameter and from about 0.5 mm to about 1.5 mm deep.

The fire-resistant panel may be multi-functional and may facilitate conservation of space. In one embodiment, the fire-resistant panel may include at least one cable configured to facilitate wiring between at least two fire-resistant panels and at least one electronic device configured to monitor at least one of security, temperatures, humidity, gas emissions, and acoustics of the protected material. In one embodiment, the electronic device is a sensor. In one embodiment, the at least one cable is located in the passive layer and the at least one electronic device is located in the passive layer.

In one embodiment, the protected material comprises an exposed surface facing the fire-resistant panel, an unexposed surface facing opposite the fire-resistant panel, and a core located between the exposed surface and the unexposed surface. In one embodiment, the core of the protected material has an average temperature of not greater than 200° C. above its initial temperature when measured in accordance with section 3.5.3.3.(b) of MIL-PRF-32161 or section 5.5.4 of MIL-STD-3020. In one embodiment, the protected material has a thickness of not greater than 4 inches. In one embodiment, the unexposed surface has an average temperature of not greater than 200° F. when the front face (F) of the of the fire-resistant panel is exposed to a temperature of 2000° F.+/−200° F. and a heat flux of at least 204+/−16 kW/m² for a minimum duration of 30 minutes when measured in accordance with UL 1709. In one embodiment, the average temperature on the unexposed surface does not raise more than 250° F. (139° C.) above its initial temperature when tested in accordance with Appendix A of MIL-PRF-32161. In one embodiment, the temperature of any one point on the unexposed surface does not raise more than 325° F. (181° C.) above its initial temperature when tested in accordance with Appendix A of MIL-PRF-32161.

In one aspect, an apparatus comprises a fire-resistant panel. The fire-resistant panel includes a passive layer comprising a phyllosilicate material and a back layer comprising an inorganic material and coupled to the passive layer. In one embodiment, the fire-resistant panel includes a secondary layer comprising a functional material, where the functional material comprises one of a phase change material or an endothermic material.

Methods of facilitating high fire resistance are also provided. In one embodiment, a method includes the steps of (a) attaching a fire-resistant panel to a protected material, where the fire-resistant panel comprises a passive layer comprising a phyllosilicate material and a back layer comprising an inorganic material, where the protected material comprises an exposed surface, an unexposed surface, and a core, and (b) impeding, in the presence of fire and via the passive layer and back layer, heat transfer to the protected material. During the impeding step, the core of the protected material has an average temperature of not greater than 200° C. above its initial temperature when measured in accordance with section 3.5.3.3(b) of MIL-PRF-32161 or section 5.5.4 of MIL-STD-3020. In one embodiment, the protected material has a thickness of not greater than 4.0 inches. In one embodiment, the average temperature on the unexposed surface does not raise more than 250° F. (139° C.) above its initial temperature when tested in accordance with Appendix A of MIL-PRF-32161. In one embodiment, the temperature of any one point on the unexposed surface does not raise more than 325° F. (181° C.) above its initial temperature when tested in accordance with Appendix A of MIL-PRF-32161.

In one embodiment, a method includes the attaching step (a), the impeding step (b), and the step of extracting heat from the passive layer via a secondary layer, where the secondary layer comprises a functional material. During the extracting step, the functional material undergoes an endothermic chemical change at a temperature of at least about 220° C. at ambient pressure resulting in the release of steam.

In one embodiment, a method includes the attaching step (a), the impeding step (b), and the step of producing steam, via a secondary layer, to facilitate a reduction in the partial pressure of oxygen proximal the fire-resistant panel. During the producing step, the secondary layer releases a gas upon attaining a temperature of about 100° C. when measured with a differential scanning calorimetry (DSC).

In another aspect, methods of producing a fire-resistant panel are provided. In one embodiment, a method includes the steps of (a) mixing a phyllosilicate material with an inorganic binder to form a mixture, (b) pressing the mixture of the phyllosilicate material and inorganic binder into a board, and (c) attaching an inorganic material to the board to form a fire-resistant panel.

In one embodiment, a method includes the mixing step (a), the pressing step (b), the attaching step (c) and the step of creating a recessed portion in the board. In one embodiment, the recessed portion contains a functional material. The functional material comprises one of a phase change material or an endothermic material. In one embodiment, a method includes the mixing step (a), the pressing step (b), the attaching step (c), and the steps of blending a functional material with one of an inorganic binder or paste to form a mixture, and applying, after the blending step, the mixture to the fire-resistant panel.

Various ones of the inventive aspects noted hereinabove may be combined to yield various fire-resistant systems, methods, and apparatus. These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 is a perspective view of one embodiment of a fire-resistant structure useful in accordance with the present disclosure.

FIG. 2 is a perspective view of one embodiment of a fire-resistant structure useful in accordance with the present disclosure.

FIG. 3 is a perspective view of one embodiment of a fire-resistant structure useful in accordance with the present disclosure.

FIG. 4 is a perspective view of one embodiment of a fire-resistant structure useful in accordance with the present disclosure.

FIG. 5 is a perspective view of one embodiment of a fire-resistant structure useful in accordance with the present disclosure.

FIG. 6 is a perspective view of one embodiment of a fire-resistant structure useful in accordance with the present disclosure.

FIG. 7 is a flow chart of one embodiment of methods useful in facilitating high fire resistance.

FIG. 8 is a flow chart of one embodiment of methods useful in producing fire-resistant systems.

FIG. 9 illustrates one embodiment of a fire-resistant structure and testing data associated therewith.

FIG. 10 illustrates one embodiment of a fire-resistant structure and testing data associated therewith.

FIG. 11 illustrates one embodiment of a fire-resistant structure and testing data associated therewith.

FIG. 12 illustrates one embodiment of a fire-resistant structure and testing data associated therewith.

FIG. 13 illustrates one embodiment of a fire-resistant structure and testing data associated therewith.

FIG. 14 illustrates one embodiment of a fire-resistant structure and testing data associated therewith.

FIG. 15 illustrates one embodiment of a fire-resistant structure and testing data associated therewith.

FIG. 16 illustrates one embodiment of a fire-resistant structure and testing data associated therewith.

### DETAILED DESCRIPTION

Reference will now be made in detail to the accompanying drawings, which at least assist in illustrating various pertinent embodiments of the present invention.

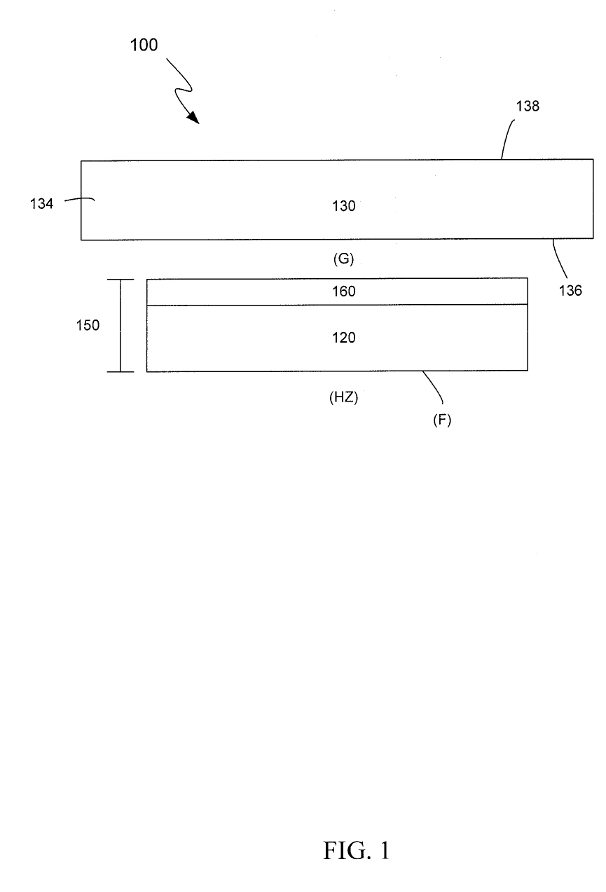

The present disclosure relates to fire-resistant systems, methods, and apparatus. In particular, the present disclosure relates to fire-resistant systems, methods, and apparatus that may have modular capability, are lightweight, and have a high fire resistance. One embodiment of a fire-resistant system is illustrated in FIG. 1. In the illustrated embodiment, the system 100 includes a protected material 130, such as a wall of a stationary or non-stationary structure. The protected material 130 may be protected from fire and/or high heat via a fire-resistant panel 150, which is coupled to the protected material 130 via any suitable attachment means (not illustrated), optionally leaving a gap (G) between the protected material 130 and the fire-resistant panel 150. The fire-resistant panel 150 includes a passive layer 120, a back layer 160, and has a front face (F) which generally is designed to face a combustion zone, fire zone and/or other type of heat producing zone (HZ).

As noted above, the protected material 130 may be protected from fire and/or heat via the fire-resistant panel 150. In one embodiment, the fire-resistant panel 150 may restrict and/or prevent damage to the protected material 130 due to heat effects (e.g., conduction, radiation) from the heat zone (HZ). In one embodiment, the fire-resistant panel 150 may restrict and/or prevent damage to the protected material 130 due to fume effects, such as a low oxygen atmosphere and/or the presence of noxious gases or vapors and/or transport of such materials beyond the fire-resistant panel 150. In this regard, the fire-resistant panel 150 may be relatively impermeable to gases produced as a result of a combustion event, and may also be relatively inert due to heat effects. In this regard, the fire-resistant panel 150 is generally heat resistant and fume resistant (e.g., has a relatively low thermal conductivity, is generally incombustible due to the heat zone), as described in further detail below.

In one embodiment, the fire-resistant panel 150, and in some instances a plurality of interconnected fire-resistant panels 150 (e.g., in a modular configuration), meet, or enable the protected material 130 to meet, as applicable, one or more requirements defined in MIL-PRF-32161 (i.e., Performance Specification-Insulation, High Temperature Fire Protection, Thermal and Acoustic, Jun. 29, 2004).

In one embodiment, the fire-resistant panel 150 meets, or enables the protected material 130 to meet, as applicable, the flame spread requirements of MIL-PRF-32161. In one embodiment, the flame spread requirements are tested in accordance with ASTM E-84, entitled “Standard Test Method for Surface Burning Characteristics of Building Materials.” In one embodiment, a flame spread index of not greater than about 25 is achieved.

In one embodiment, the fire-resistant panel 150 meets, or enables the protected material 130 to meet, as applicable, the smoke density requirements of MIL-PRF-32161. In one embodiment, the smoke density requirements are tested in accordance with ASTM E-84, entitled “Standard Test Method for Surface Burning Characteristics of Building Materials.” In one embodiment, a smoke developed index of not greater than about 50 is achieved.

In one embodiment, the fire-resistant panel 150 meets, or enables the protected material 130 to meet, as applicable, the full-scale fire resistance test requirements of MIL-PRF-32161 and/or sections 5.5.1-5.5.3 of MIL-STD-3020 (i.e., Department of Defense Standard Practice, Fire Resistance of U.S. Naval Surface Ships, Nov. 7, 2007). In one embodiment, the full-scale fire resistance test requirements are tested in accordance with Appendix A of MIL-PRF-32161. In one embodiment, the full-scale fire resistance test provides a minimum of 30 minutes of protection based on withstanding the fire endurance test without passage of flame for a time period equal to that for which the classification is desired (e.g., Class N-0 and N-30 has a time period of 30 minutes, Class N-60 has a time period of 60 minutes). In one embodiment, the full-scale fire resistance test provides a minimum of 30 minutes of protection based on transmission of heat during the fire endurance test period, not raising the average temperature on the unexposed surface 138 more than 250° F. (139° C.) above its initial temperature, nor the temperature of any one point on the surface, more than 325° F. (181° C.) above its initial temperature. In one embodiment, the core 134 of the protected material 130 may achieve an average temperature of not greater than 200° C. above its initial temperature as measured in accordance with section 3.5.3.3(b) of MIL-PRF-32161 and/or section 5.5.4 of MIL-STD-3020, the maximum thickness of the protected material 130 being not greater than four inches thick.

In one embodiment, the fire-resistant panel 150 meets, or enables the protected material 130 to meet, as applicable, the acoustical absorption requirements of MIL-PRF-32161. In one embodiment, the acoustical absorption requirements are tested in accordance with ASTM-C-423, using mounting method A of ASTM-E-795. In one embodiment, the acoustical absorption may achieve a value equal to or greater than the values in section 3.5.4.1, Table IV of MIL-PRF-32161.

In one embodiment, the fire-resistant panel 150 meets, or enables the protected material 130 to meet, as applicable, the acoustical transmission loss requirements of MIL-PRF-32161. In one embodiment, the acoustical transmission loss requirements are tested in accordance with ASTM-E-90, using the mounting method specified in ASTM-E-1123. In one embodiment, the acoustical transmission loss may achieve a value equal to or greater than the values in section 3.5.4.2, Table V of MIL-PRF-32161.

In one embodiment, the fire-resistant panel 150 meets, or enables the protected material 130 to meet, as applicable, the corrosiveness requirements of MIL-PRF-32161. In one embodiment, the corrosiveness requirements are tested in accordance with ASTM-C-665. In one embodiment, corrosion not greater than that observed with sterile cotton may be achieved.

In one embodiment, the fire-resistant panel 150 meets, or enables the protected material 130 to meet, as applicable, the disposal requirements of MIL-PRF-32161. In one embodiment, the fire-resistant panel 150 and/or the protected material 130 does not contain any hazardous material or exhibit any hazardous characteristic as defined under 40 C.F.R. 261.

In one embodiment, the fire-resistant panel 150 meets, or enables the protected material 130 to meet, as applicable, the workmanship requirements of MIL-PRF-32161. In one embodiment, the fire-resistant panel 150 and/or the protected material 130 conforms to the quality and grade of product established by MIL-PRF-32161.

In one embodiment, the unexposed surface 138 of the protected material 130 may achieve an average temperature of not greater than 200° F. when the face (F) of the fire-resistant panel 150 is exposed to a temperature of 2000° F.+/−200° F. and a heat flux of at least 204+/−16 kW/m² for a minimum duration of 30 minutes as measured in accordance with UL 1709.

The fire-resistant panels 150 may be capable of meeting, or enabling the protected material 130 to meet, as appropriate, one or more of the above properties, and each fire-resistant panel 150 may have a relatively low thickness. In one embodiment, the fire-resistant panel 150 has a thickness of not greater than about 1.3 inches. In other embodiments, the fire-resistant panel 150 has a thickness of not greater than about 1.2 inches, or not greater than about 1.1 inches, or not greater than about 1.0 inch, or not greater than about 0.9 inch, or not greater than about 0.8 inch, or not greater than about 0.7 inch, or not greater than about 0.6 inch, or not greater than about 0.5 inch, or not greater than about 0.4 inch, or not greater than about 0.3 inch, or not greater than about 0.25 inch.

The fire-resistant panel 150 may be capable of meeting, or enabling the protected material 130 to meet, as appropriate, one or more of the above properties, and each fire-resistant panel 150 may have a relatively low density. In one embodiment, the fire-resistant panel 150 has a density of not greater than about 2 g/cm³. In other embodiments, the fire-resistant panel 150 has a density of not greater than about 1.9 g/cm³, or of not greater than about 1.8 g/cm³, or of not greater than about 1.7 g/cm³, or of not greater than about 1.6 g/cm³, or of not greater than about 1.5 g/cm³, or of not greater than about 1.4 g/cm³, or of not greater than about 1.3 g/cm³, or of not greater than about 1.2 g/cm³, or of not greater than about 1.1 g/cm³, or of not greater than about 1.0 g/cm³, or of not greater than about 0.9 g/cm³, or of not greater than about 0.8 g/cm³, or of not greater than about 0.7 g/cm³, or of not greater than about 0.6 g/cm³, or of not greater than about 0.5 g/cm³.

As noted above and with reference to the illustrated embodiment, the fire-resistant panel 150 includes a passive layer 120. The passive layer 120 generally includes a front face (F), which faces the fire and/or heat source (HZ). In one embodiment, the passive layer 120 may be flexible to facilitate portability and modular application of the system. For example, the passive layer 120 may be easy to handle, transport, and apply to the protected material 130. In one embodiment, the passive layer 120 may impede heat transfer to the protected material 130 and/or additional layers of the fire-resistant panel 150.

To achieve one or more of the above properties, the passive layer 120 may generally have a high melting point. In one embodiment, the passive layer 120 has a melting point of at least about 600° C. In other embodiments, the passive layer 120 has a melting point of at least about 700° C., or at least about 800° C., or at least about 900° C., or at least about 1000° C., or at least about 1100° C., or at least about 1200° C., or at least about 1300° C., or at least about 1400° C. In one embodiment, the passive layer 120 has a melting point in the range of about 600° C. to about 1400° C.

To achieve one or more of the above properties, the passive layer 120 may have a high sintering temperature (i.e., the temperature at which materials particles within a material begin to adhere to one another, such as in a ceramic material, but below the melting point of a material). In one embodiment, the passive layer 120 has a sintering temperature of at least about 1000° C. In other embodiments, the passive layer 120 has a sintering temperature of at least about 1050° C., or at least about 1100° C., or at least about 1150° C.

The passive layer 120 may have a low bulk density to facilitate portability (e.g., easier to handle, transport and/or apply) and/or restricted heat transfer. In one embodiment, the passive layer 120 has a bulk density of not greater than about 1.6 g/cm³. In other embodiments, the passive layer 120 has a bulk density of not greater than about 1.5 g/cm³, or of not greater than about 1.4 g/cm³, or of not greater than about 1.3 g/cm³, or of not greater than about 1.2 g/cm³, or of not greater than about 1.1 g/cm³, or of not greater than about 1.0 g/cm³, or of not greater than about 0.9 g/cm³, or of not greater than about 0.8 g/cm³, or of not greater than about 0.7 g/cm³, or of not greater than about 0.6 g/cm³. In one embodiment, the passive layer 120 has a bulk density in the range of about 0.6 g/cm³ to about 1.6 g/cm³.

To achieve one or more of the above properties, the passive layer 120 may have a low thermal conductivity. In one embodiment, the passive layer 120 has a thermal conductivity of not greater than about 1 W/(m*K). In other embodiments, the passive layer 120 has a thermal conductivity of not greater than about 0.75 W/(m*K), or of not greater than about 0.50 W/(m*K), or of not greater than about 0.25 W/(m*K), or of not greater than about 0.15 W/(m*K), or of not greater than about 0.10 W/(m*K), or of not greater than about 0.05 W/(m*K). In one embodiment, the passive layer 120 has a thermal conductivity in the range of about 0.05 W/(m*K) to about 1.0 W/(m*K).

To achieve one or more of the above properties, the passive layer 120 may have a high specific heat capacity. In one embodiment, the passive layer 120 has a specific heat capacity of at least about 0.8 kJ/kg*K. In other embodiments, the passive layer 120 has a specific heat capacity of at least about 0.9 kJ/kg*K, or at least about 1.0 kJ/kg*K, or at least about 1.1 kJ/kg*K. In one embodiment, the passive layer 120 has a specific heat capacity in the range of about 0.8 kJ/kg*K to 1.1 kJ/kg*K.

The passive layer 120 may have a high compressive strength to facilitate durability. In one embodiment, the passive layer 120 has a compressive strength of at least about 1.0 MPa. In other embodiments, the passive layer 120 has a compressive strength of at least about 1.3 MPa, or at least about 1.6 MPa, or at least about 1.9 MPa, or at least about 2.2 MPa, or at least about 2.5 MPa, or at least about 2.8 MPa, or at least about 3.1 MPa, or at least about 3.4 MPa, or at least about 3.7 MPa, or at least about 4.0 MPa, or at least about 4.3, or at least about 4.6 MPa, or at least about 4.9 MPa. In one embodiment, the passive layer 120 has a compressive strength in the range of about 1.0 MPa to about 5.0 MPa.

The passive layer 120 may have a high porosity to at least partially assist in restricting heat transfer and/or to at least partially facilitate portability. In one embodiment, the passive layer 120 has a porosity of at least about 85%.

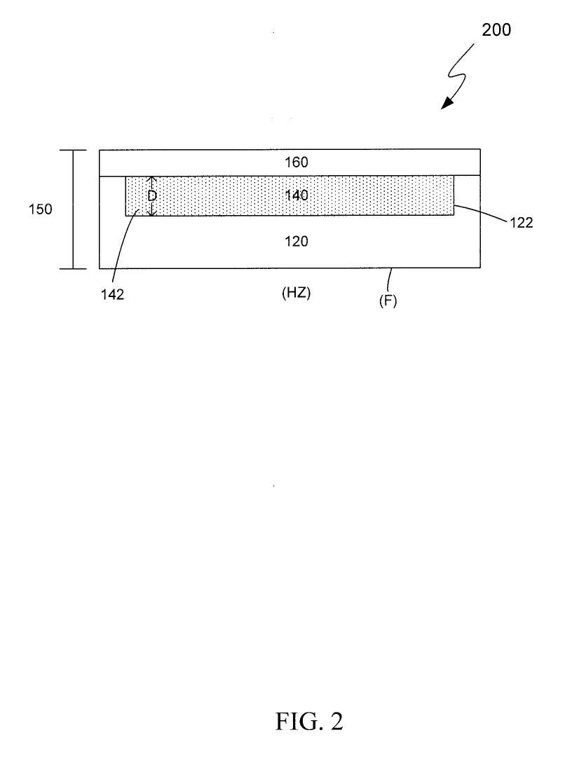

In one embodiment, the passive layer 120 may have a coefficient of thermal expansion that is similar to the coefficient of thermal expansion of secondary layer 140 (illustrated in FIG. 2) and/or back layer 160. These similar coefficients of thermal expansion may at least assist in maintaining the coupling of the secondary layer 140 and/or back layer 160 to the passive layer 120. The passive layer 120 may also be relatively flexible so as to facilitate the portability and modular application of the system 100. In one embodiment, the passive layer 120 has a coefficient of thermal expansion of not greater than about 15×10⁻⁶ K. In other embodiments, the passive layer 120 has a coefficient of thermal expansion of not greater than about 14×10⁻⁶ K, or of not greater than about 13×10⁻⁶ K, or of not greater than about 12×10⁻⁶K, or of not greater than about 11×10⁻⁶ K, or of not greater than about 10×10⁻⁶ K, or of not greater than about 9×10⁻⁶ K, or of not greater than about 8×10⁻⁶ K, or of not greater than about 7×10^{Γ6} K. In one embodiment, the passive layer 120 has a coefficient of thermal expansion in the range of about 7×10⁻⁶ K to about 15×10⁻⁶ K.

The passive layer 120 may comprise any suitable material meeting at least some of these criteria, such as minerals, clays and/or ceramics. In one embodiment, the passive layer 120 comprises a phyllosilicate material (e.g., vermiculite in exfoliated form). The vermiculite may be in board form and with or without an inorganic binder. In one embodiment, the vermiculite is relatively asbestos-free.

Vermiculite (sometimes having the chemical formula (MgFe,Al)₃(Al,Si)₄O₁₀(OH)₂.4H₂O) is a hydrated magnesium-iron-aluminum silicate material, having a platelet-type crystalline structure (e.g., monoclinical). Vermiculite has a high porosity, high void volume to surface area ratio, and a low density. Vermiculite is generally insoluble in both water and organic solvents. Vermiculite has a bulk density generally in the range of about 0.60 g/cm³ to about 1.6 g/cm³. Vermiculite has a thermal conductivity generally in the range of about 0.04 W/(m*K) to about 0.12 W/(m*K). Vermiculite has a specific heat capacity in the range of from about 0.8 kJ/kg*K to about 1.1 kJ/kg*K. Vermiculite has a melting point generally in the range of from about 1200° C. to about 1400° C., and a sintering temperature in the range of from about 1150° C. to about 1250° C. Vermiculite may have a porosity generally in the range of from about 75% to about 86%. To produce a passive layer 120 comprising vermiculite, vermiculite, e.g., in exfoliated form, may be mixed with an inorganic binder and pressed into a board. Suitable vermiculite boards may include the V1100 Series and may be obtained from Skamol Americas, Inc., 10100 Park Cedar Drive, Suite 124, Charlotte, N.C. 28210, Tel: (704) 544-1015.

The passive layer 120 should be thick enough to adequately prevent heat effects from materially affecting the protected material 130. The passive layer 120 should be thin enough so as to reduce the density of the fire-resistant panel 150 and/or reduce its occupying volume and/or facilitate modular construction and/or installation of the fire-resistant panel 150 relative to the protected material 130. The use of thin passive layers 120 may facilitate stacking of a series of fire-resistant panels 150. In one embodiment, the passive layer 120 generally has a thickness of at least about 6 mm. In other embodiments, the passive layer 120 has a thickness of at least about 12 mm, or at least about 18 mm, or at least about 24 mm, or at least about 30 mm, or at least about 36 mm, or at least about 42 mm, or at least about 48 mm.

In the illustrated embodiment, the passive layer 120 is of a generally rectangular shape (e.g., a board or panel-like configuration). In other embodiments, the passive layer 120 may be of a different configuration. In one embodiment, the passive layer comprises a vermiculite-containing board, such as those produced by Skamol, Nykøbing Mors, Denmark.

A fire-resistant panel 150 may include one or more passive layers 120 and at various locations, such as, for example, those locations disclosed herein. Furthermore, the fire-resistant panel 150 may include one or multiple passive layers 120 at a single location. In some embodiments, a fire-resistant panel 150 includes one or more passive layers 120.

In one embodiment, and with reference now to FIG. 2, the fire-resistant panel 150 may include a secondary layer 140. The secondary layer 140 may be used, for example, to facilitate preservation of the passive layer 120, protected material 130 and/or fire-resistant panel 150. The fire-resistant panel 150 may include one or more secondary layers 140 and at various locations, such as, for example, those locations disclosed herein. Furthermore, the fire-resistant panel 150 may include one or multiple secondary layers 140 at a single location. In some embodiments, a fire-resistant panel 150 includes one or more secondary layers 140. In other embodiments, a fire-resistant panel 150 may be absent of a secondary layer 140 (e.g., include only a passive layer 120, but not a secondary layer 140).

In one embodiment, the secondary layer 140 may include a functional material 142. The functional material 142 may facilitate extraction of heat and/or deprivation of oxygen to its surroundings, among other functionalities. In one embodiment, the functional material 142 comprises one of a phase-change material or an endothermic material (e.g., a chemical change material).

In one embodiment, the functional material 142 undergoes a chemical change (e.g., a chemical reaction) in the presence of heat and this chemical change is endothermic. In one embodiment, the chemical change material is aluminium-tri-hydrate (ATH) or Al(OH)₃. ATH is endothermically reduced to alumina (Al₂O₃) and water (liquid or steam H₂O) in the presence of heat (e.g., at a temperature of at least about 220° C. at ambient pressure). Energy from the passive layer 120 may be transferred to the secondary layer 140 and/or the protected material 130 concomitant to this chemical change, which may result in extraction of heat from the passive layer 120 and/or cooling of the passive layer 120 and/or the protected material 130. In turn, the passive layer 120 may be maintained for a greater period of time. Another benefit to the use of ATH is the production of steam, which may reduce the partial pressure of oxygen proximal the heating zone (HZ), as described in further detail below. In one embodiment, the passive layer 120 may have perforations to facilitate venting of the steam.

In one embodiment, the functional material 142 undergoes a phase change (e.g., a change of state from solid to liquid, liquid to gas, and the reverse of these) and this phase change may result in the transfer of energy from the passive layer 120 to the secondary layer 140. For example, due to the principles of latent heat of fusion and/or the latent heat of vaporization, energy may be transferred from the passive layer 120 to the secondary layer 140, which may result in extraction of heat from the passive layer 120 and/or cooling of the passive layer 120 and/or the protected material 130. In turn, the passive layer 120 may be maintained for a greater period of time. In one embodiment, the phase change material is copper. Copper has a melting point of about 1084° C., and therefore copper may at least partially assist to absorb the heat from the passive layer 120 and/or the heating zone (HZ) due to it having a melting point lower than that of materials that the passive layer 120 may comprise. If lithium-type fires are an issue, the copper may also form a non-combustible copper-lithium alloy on the surface which may also reduce/restrict the amount of oxygen proximal the material to be protected 130 and/or proximal the heated zone (HZ).

In one embodiment, the secondary layer 140 comprises at least some oxygen-depriving material, which acts to reduce/restrict the amount of oxygen proximal the heat zone (HZ). For example, the secondary layer 140 may release a gas upon attaining a predetermined temperature, which may reduce the partial pressure of oxygen proximal the heating zone (HZ). For example, when ATH decomposes to alumina plus water, some steam may be produced. This steam may be released to the heating zone (HZ) via passages (e.g., designed and/or predetermined passageways) in the fire-resistant panel 150, which will act to reduce the amount of oxygen available in the heating zone (HZ). In turn, the presence of combustion and/or fire may be reduced and/or eliminated in the heating zone (HZ).

In one embodiment, the functional material 142 is sodium bi-carbonate (NaHCO₃), which has a melting point of about 50° C. (ambient pressure) and decomposes into sodium carbonate, water, and carbon dioxide (Na₂CO₃+H₂O+CO₂) at about 70° C. The release of H₂O and CO₂ may create a positive partial pressure, and this may further assist the sodium bi-carbonate in reducing/restricting the amount of oxygen proximal the material to be protected 130 and/or proximal the heated zone (HZ). Thus, sodium bi-carbonate may be a chemical change material as well as an oxygen depriving material, as described above.

Functional materials 142 may be used in the secondary layer 140 and in any combination. Chemical change or phase change materials may be used solely or in combination with one another. Functional materials 142 other than those described above may be used in the secondary layer 140. For example, functional materials 142 that undergo endothermic reaction at a temperature of interest and that are relatively inert in the presence of high temperatures may be utilized. Functional materials 142 that undergo a phase change at a temperature of interest and that are relatively inert in the presence of high temperatures may be utilized.

In the illustrated embodiment of FIG. 2, a single secondary layer 140 is located proximal the passive layer 120 via one large recessed portion 122 on the side opposite the front face (F) and coupled to the passive layer 120 via back layer 160. The at least one recessed portion 122 contains at least some of the functional material 142. In one embodiment, the passive layer 120 includes only one large recessed portion 122. In other embodiments, the passive layer 120 includes multiple recessed portions 122, and at least some of the plurality of recessed portions 122 including at least some of the functional material 142. In some embodiments, a majority, or even all, of the multiple recessed portions 122 include at least some of the functional material 142. In some embodiments, the majority, or even all, of the volume of the at least one recessed portion 122 is occupied by the functional material 142. In yet other embodiments, described below, the passive layer 120 does not include a recessed portion 122.

In the illustrated embodiment, the recessed portion 122 has a depth (D) in the range of about 1/16 of an inch to about 5/16 of an inch. In one embodiment, the recessed portion 122 has a depth (D) of at least about 1/16 of an inch. In other embodiments, the recessed portion 122 has a depth (D) of at least about 2/16 of an inch deep. In one embodiment, the recessed portion 122 has a depth (D) not greater than about 5/16 of an inch. In other embodiments, the recessed portion 122 has a depth (D) not greater than about 4/16 of an inch.

In other embodiments (not illustrated), the secondary layer 140 may be located proximal to the passive layer 120 via other suitable arrangements. In one embodiment, as noted above, the secondary layer 140 may be located proximal the passive layer 120 via a plurality of recessed portions 122 on the side opposite the front face (F).

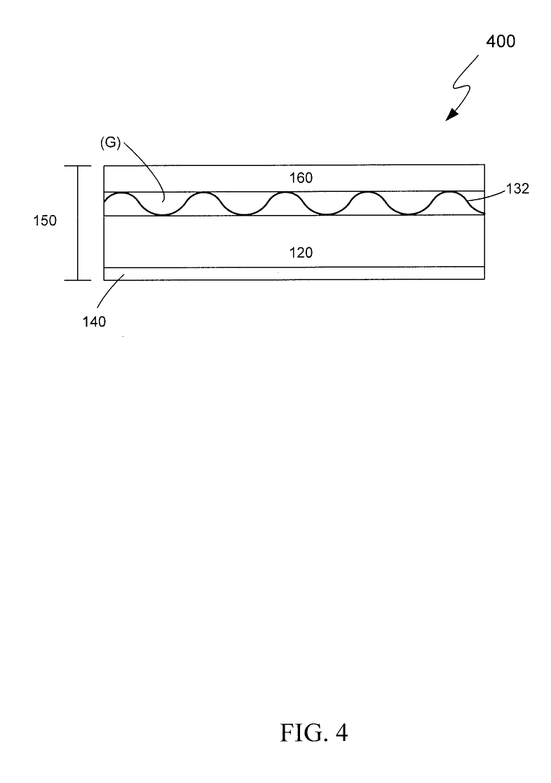

The secondary layer 140 may be in any suitable physical form. In one embodiment, the secondary layer 140 is in the form of a loose powder (e.g., ATH or sodium bi-carbonate powders). In other embodiments, the secondary layer 140 may be a cohesive material, such as in the form of a solid. In one embodiment, this may be achieved by blending the functional material 142 with a binder (e.g., inorganic) and/or paste and then applying this mixture to the passive layer 120. For example, the functional material 142 may be mixed with refractory based adhesives and/or pastes (e.g., silicon or zirconium, to name a few) and then applied (e.g., pasted and/or painted) onto the front face (F) of the passive layer 120, as illustrated in FIG. 4. Additionally, the functional material 142 may be located proximal the passive layer 120 by pressing the passive layer 120 particles with an inorganic binder (e.g., silica, silicon or zirconium, to name a few).

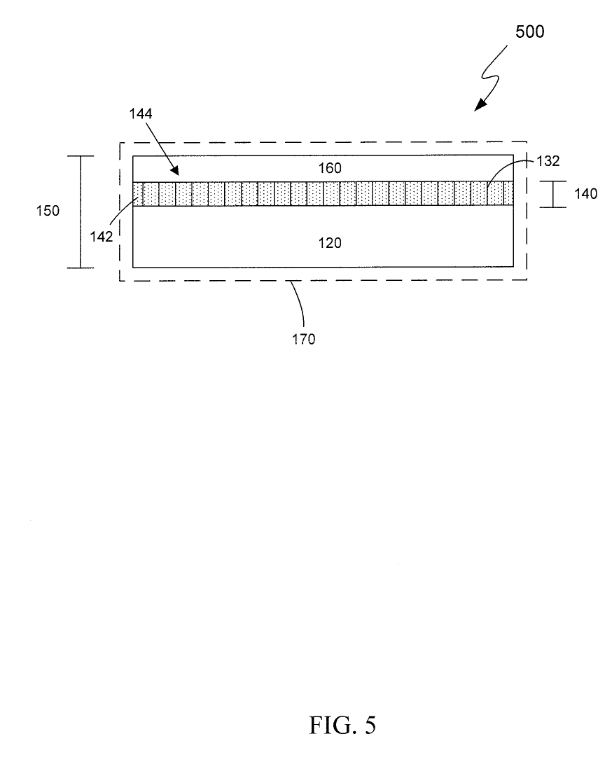

In some embodiments, and with reference now to FIG. 5, the secondary layer 140 may be located proximal the passive layer 120 via a separate supporting member 144 (e.g., a honeycomb structure) proximal (e.g., coupled to) the passive layer 120. The separate supporting member 144 may be metallic (e.g., aluminum, titanium, stainless steel, to name a few) or organic (e.g., silicone based non-flammable rubber). In one embodiment, the separate supporting member 144 may facilitate attachment of the fire-resistant panel 150 to the protected material 130. For example, a spacer forming an air-gap between the separate supporting member 144 and the protected material 130 may attach to the protected material 130 and a substrate (e.g., an inorganic non-flammable adhesive) located on the separate supporting member 144. In one embodiment, the separate supporting member 144 may act as a shock absorber, e.g., the separate supporting member will expand and/or collapse upon encountering an impact.

In some embodiments, the secondary layer 140 may be located proximal the passive layer 120 via blending or impregnation of the functional material 142 with the passive layer 120 as the passive layer 120 is manufactured. In one embodiment, the functional material 142 may be mixed with an intumescent paint and applied to the corners of the fire-resistant panel 150.

The secondary layer 140 may be located proximal the passive layer 120 in any suitable arrangement and with any combination of the above mentioned embodiments. In some embodiments, the secondary layer 140 is located proximal one or more passive layers 120 and/or one or more back layers 160. For example, the secondary layer 140 may be produced as a paste and placed between adjacent fire-resistant panels 150, passive layers 120 and the like. In this embodiment, the secondary layer 140 may act to caulk the joints of a fire-resistant panel 150. Other combinations are possible.

Referring back to FIG. 1, the fire-resistant panel 150 may include a back layer 160. The back layer 160 may be coupled directly to the passive layer 120. The back layer 160 may be used, for example, to couple other layers of the fire-resistant panel 150 (e.g., the passive layer 120 and/or the secondary layer 140) to the protected material 130. The back layer 160 may impede heat transfer to the protected material 130 and/or may distribute and/or diffuse any gases released by the secondary layer 140. The back layer 160 may be porous (e.g., uniformly porous) to facilitate the passage of steam and/or any suitable oxygen depriving gases through it. The back layer 160 may have pores small enough to assist in the containment of the secondary layer 140 within the fire-resistant panel 150. The back layer 160 may facilitate containment of one or more secondary layers 140 within the fire-resistant panel 150, such as when one or more recessed portions 122 are used within a passive layer 120.

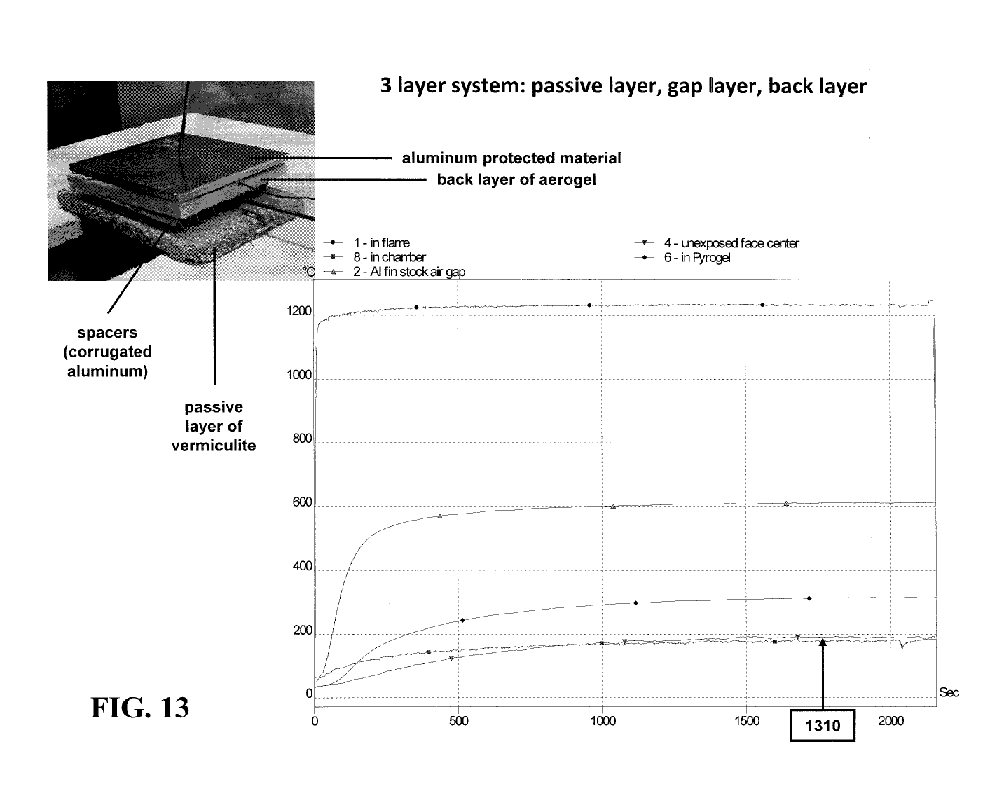

The fire-resistant panel 150 may include one or more back layers 160 and at various locations, such as, for example, those locations disclosed herein. Furthermore, the fire-resistant panel 150 may include one or multiple secondary layers 140 at a single location. In some embodiments, a fire-resistant panel 150 includes one or more back layers 160. In other embodiments, a fire-resistant panel 150 may be absent of a back layer 160 (e.g., includes only a passive layer 120 and/or a secondary layer 140). The use of the term “back” layer does not necessarily mean that this layer is in the “back” of the fire-resistant panel. For example, and with reference to FIG. 13, the back layer 160 actually faces the front of the heating zone (HZ).

To achieve one or more of the above properties, the back layer 160 may generally have a high melting point. In one embodiment, the back layer 160 has a melting point of at least about 600° C. In other embodiments, the back layer 160 has a melting point of at least about 700° C., or at least about 800° C., or at least about 900° C., or at least about 1000° C., or at least about 1100° C., or at least about 1200° C., at least about 1300° C., at least about 1400° C. In one embodiment, the back layer 160 has a melting point in the range of about 600° C. to about 1400° C.

To achieve one or more of the above properties, the back layer 160 may generally have a low thermal conductivity. In one embodiment, the back layer 160 has a thermal conductivity of not greater than about 0.025 W/mK at about 25° C. In other embodiments, the back layer 160 has a thermal conductivity of not greater than about 0.024 W/mK, or of not greater than about 0.023 W/mK, or of not greater than about 0.022 W/mK, or of not greater than about 0.021 W/mK, or of not greater than about 0.02 W/mK, or of not greater than about 0.019 W/mK, or of not greater than about 0.018 W/mK, or of not greater than about 0.0175 W/mK. In one embodiment, the back layer 160 has a thermal conductivity in the range of about 0.0175 W/mK to about 0.025 W/mK.

The back layer 160 may have a low bulk density to facilitate portability and/or restricted heat transfer. In one embodiment, the back layer 160 has a bulk density of not greater than about 4.0 g/cm³. In other embodiments, the back layer 160 has a bulk density of not greater than about 3.0 g/cm³, or of not greater than about 2.0 g/cm³, or of not greater than about 1.0 g/cm³, or of not greater than about 0.5 g/cm³, or of not greater than about 0.35 g/cm³, or of not greater than about 0.3 g/cm³, or of not greater than about 0.25 g/cm³, or of not greater than about 0.20 g/cm³, or of not greater than about 0.15 g/cm³, or of not greater than about 0.10 g/cm³, or of not greater than about 0.05 g/cm³, or of not greater than about 0.01 g/cm³. In one embodiment, the back layer 160 has a bulk density in the range of about 0.01 g/cm³ to about 4.0 g/cm³.

The back layer 160 may have a coefficient of thermal expansion that is similar to the coefficient of thermal expansion of secondary layer 140 and/or passive layer 120. These similar coefficients of thermal expansion may at least assist in maintaining the coupling of the secondary layer 140 to the passive layer 120. The back layer 160 may also be relatively flexible so as to facilitate the portability and modular application of the system 100. The back layer 160 may be hydrophobic. In one embodiment, the back layer 160 may have a maximum use temperature of not greater than about 650° C. In one embodiment, the back layer 160 may have a thickness of not greater than about 6 mm.

The back layer 160 may comprise any suitable material meeting at least some of these criteria, such as metals and/or inorganic materials, e.g., inorganic blankets. In one embodiment, the back layer 160 comprises amorphous silica and/or mineral wools. In one embodiment, the back layer 160 comprises a flexible aerogel. In one embodiment, the back layer 160 consists essentially of a flexible aerogel. In one embodiment, the flexible aerogel is relatively non-toxic.

One type of flexible aerogel is an aerogel blanket. An aerogel blanket may include (e.g., be a composite of) silica aerogel and fibers (e.g., for reinforcement). An aerogel blanket is a flexible, porous material.

In some embodiments, an aerogel has a dendritic microstructure, in which spherical particles of average size 2-5 nm may be fused together into clusters. These clusters may form a three-dimensional microporous or nanoporous structure of almost fractal chains (e.g., with pores smaller than 100 nm). Aerogel may have a high porosity, high void volume to surface area ratio, a low density, and a low thermal conductivity. An aerogel may act as a desiccant, which may facilitate attraction of water molecules (e.g., via adsorption or absorption). An aerogel may be comprised of silica (SiO₂). Silica-containing aerogels may have a bulk density generally in the range of about 480 kg/m³ to about 720 kg/m³. Silica-containing aerogels may have a thermal conductivity in the range of about 0.004 W/m*K to about 0.03 W/m*K. Silica-containing aerogels may have a specific heat capacity in the range of from about 1.0 kJ/kg*K to about 1.2 kJ/kg*K. Silica-containing aerogels may have a melting point generally in the range of from about 1000° C. to about 1400° C. Silica-containing aerogels may have a coefficient of thermal expansion in the range of from about 2.0 um/K to about 4.0 um/K. Suitable aerogel materials may include the Pyrogel Series 6671, XT, and/or XTF and may be obtained from Aspen Aerogels, Inc., 30 Forbes Road, Building B, Northborough, Mass. 01532, Tel: (508) 691-1111.

The back layer 160 may be included in a fire resistant panel 150 in any suitable arrangement. For example, and with reference to FIG. 2, a back layer 160 may be coupled to at least a portion of the passive layer 120 and the secondary layer 140. In this arrangement, the back layer 160 may facilitate containment of the secondary layer 140, may impede heat transfer through the fire-resistant panel 150, and/or may facilitate selective diffusion of gases (e.g., from the secondary layer 140) out of the fire-resistant panel 150.

In another arrangement, and with reference now to FIG. 1, a back layer 160 may be directly coupled to a passive layer 120. In this arrangement, the back layer 160 may impede heat transfer through the fire-resistant panel 150.

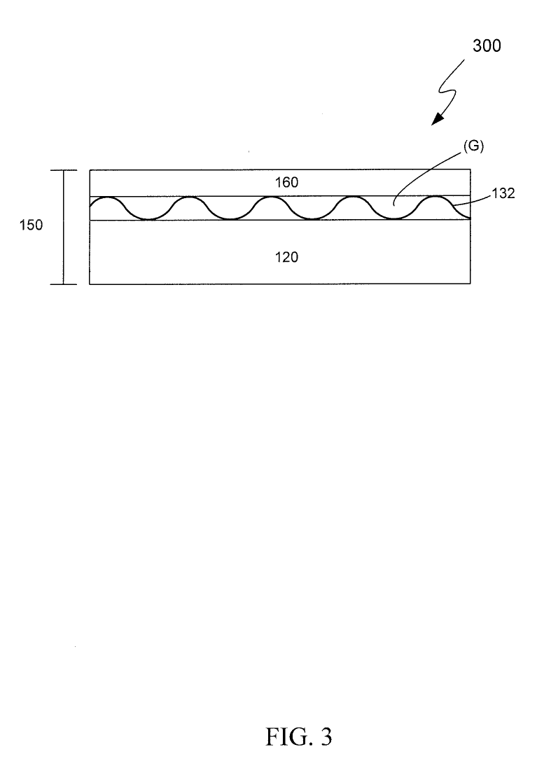

In another arrangement, and with reference now to FIGS. 3 and 4, a back layer may be coupled to a passive layer 120 via intervening spacers 132. In this arrangement, the back layer 160 may impede heat transfer through the fire-resistant panel 150. Furthermore, the spacers 132 may create a gap (G) between the layers, which may further impede heat transfer through the fire-resistant panel 150.

In another arrangement, and with reference now to FIG. 5, a back layer 160 may be coupled to the separate supporting structure 144, which at least partially defines the secondary layer 140. The separate supporting structure 144 may include a plurality of recesses for containing functional material 142. One or more of these recesses may be filled with functional material 142. In the illustrated embodiment, all of the recessed are filled with functional material 142, but this is not required. In this arrangement, the back layer 160 may facilitate containment of the secondary layer 140, may impede heat transfer through the fire-resistant panel 150, and/or may facilitate selective diffusion of gases (e.g., from the secondary layer 140) out of the fire-resistant panel 150. The back layer 160 may also be used to couple the fire-resistant panel 150 to the protected material 130.

The fire-resistant panel 150 may include a wrap. Referring now to FIG. 5, in this embodiment, the fire-resistant panel 150 includes a wrap 170, which may be used to at least partially assist in providing structural integrity to the fire-resistant panel 150. In one embodiment, the wrap 170 may facilitate containment of dust due to the passive layer 120 and/or the functional material 142. In the illustrated embodiment, the wrap 170 surrounds the fire-resistant panel 150. In other embodiments, the wrap 170 only contacts a portion of the fire-resistant panel 150. For example, the wrap 170 may contact the sides and/or the back of the fire-resistant panel 150. The wrap 170 may be made of aluminum foil, metal foil, woven fiberglass and/or amorphous silica fabric or blanket, to name a few.

Referring now to FIGS. 3 and 4, the fire-resistant panel 150 may include one or more spacers 132. The spacers 132 may create a gap (G) between layers and may have a low surface area to restrict thermal conductivity through the protected material 130. The spacers 132 may act as a shock absorber, e.g., the spacers 132 will expand and/or collapse upon encountering an impact. The gap (G) may allow expansion and/or evaporation of any and/or all of the layers of fire-resistant panel 150 so as to facilitate radiant cooling and/or maintain structure durability. The spacers 132 may be aluminum finstock, aluminum expanded metal, vermiculite, or any other suitable material spacer (e.g., shims, dimples on the aluminum foil, blocks, bars, to name a few). In one embodiment, the spacers 132 may be built into, molded into, and/or machined into any layer of the fire-resistant panel 150. In one embodiment, the spacers 132 may be adhesively attached to the wrap 170.

In some embodiments, the passive layer 120 may have patterned spacers 132 on one or both sides of the surface of the passive layer 120. The patterned spacers 132 may be in the form of protrusions of the passive layer 120. For example, the spacers 132 may be in the range of about 1 mm in diameter to about 5 mm in diameter and spaced in the range of about 11 mm to about 15 mm apart. The spacers 132 may be in the range of about 0.5 mm deep to about 1.5 mm deep and in the range of about 1 mm to about 2 mm in diameter. In one embodiment, multiple passive layers 120 at a single location or at various locations may have patterned spacers 132. In one embodiment, the patterned spacers 132 may contain the functional material 142.

Referring back to FIG. 1, the protected material 130 may include an exposed surface 136 facing the fire-resistant panel 150, an unexposed surface 138 facing opposite the fire-resistant panel 150, and a core 134 located between the exposed surface 136 and the unexposed surface 138. In one embodiment, the protected material 130 is a wall of a vehicle, such as a boat or other type of submersible watercraft. In other embodiments, the protected material 130 may be residential and commercial buildings, architectural, off-shore drilling rigs for oil and gas, passenger vessels (e.g., ferries, cruise ships) or any structure suitable for fire protection.

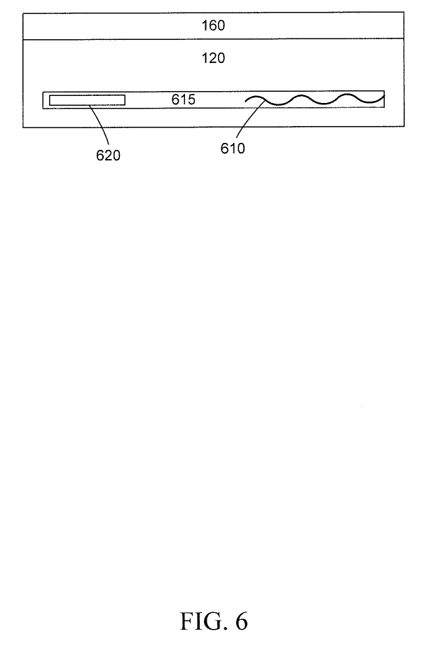

The fire-resistant panel 150 may have features and/or functions in addition to having fire, heat, and fume resistance. In one example, the fire-resistant panel 150 is multi-functional and may facilitate conservation of space. In another example, and with reference now to FIG. 6, the fire-resistant panel 150 may include at least one cable 610 (illustrated via cut-away view 615 of the passive layer 120) configured to facilitate wiring between at least two fire-resistant panels 150. In one embodiment, the at least one cable 610 may be a conductor capable of carrying electricity over a distance. For example, a first portion of the cable 610 may be located in a first fire-resistant panel 150 and a second portion of cable 610 may be located in a second fire-resistant panel 150 to facilitate electrical transmission between the first and second fire-resistant panels 150. In one embodiment, the cable 610 may be used to transmit electricity from a first fire-resistant panel 150 to a second fire-resistant panel 150. In one embodiment, the cable 610 may be a fiber optic cable. In one embodiment, the cable 610 is located in the passive layer 120.

In one embodiment, the fire-resistant panel 150 may include at least one electronic device 620 (illustrated via cut-away view 615 of the passive layer 120) configured to monitor at least one of security, temperatures, humidity, gas emissions, and acoustics of the protected material 130. In one embodiment, the electronic device 620 may be any device capable of processing and responding to a signal or stimulus (e.g., heat, pressure, light, or motion, to name a few). In one embodiment, the electronic device 620 may be a sensor. For example, a sensor may be used in the fire-resistant panel 150 to monitor and report at least one of security, temperatures, humidity, gas emissions, and acoustics of the protected material 130. In one embodiment, the electronic device 620 may be located in the passive layer 120.

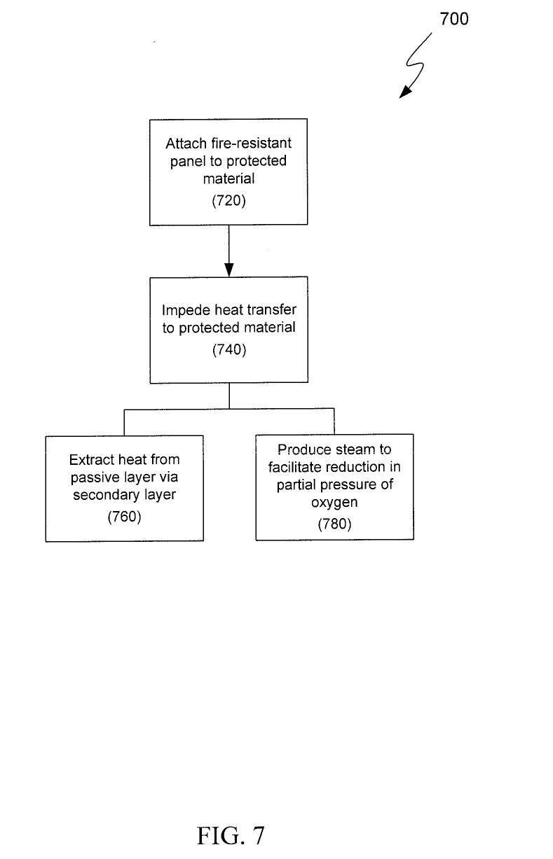

Methods of facilitating high fire resistance are also provided. In one embodiment, and with reference to FIG. 7, the method 700 includes the steps of attaching a fire-resistant panel to a protected material (720), where the fire-resistant panel comprises a passive layer comprising a phyllosilicate material and a back layer comprising an inorganic material, where the protected material comprises an exposed surface, an unexposed surface, and a core, and impeding, in the presence of fire and via the passive layer and back layer, heat transfer to the protected material (740). During the impeding step (740), the core of the protected material has an average temperature of not greater than 200° C. above its initial temperature when measured in accordance with section 3.5.3.3(b) of MIL-PRF-32161 or section 5.5.4 of MIL-STD-3020.

In one embodiment, the method 700 includes the attaching step (720), the impeding step (740), and the step of extracting heat from the passive layer via a secondary layer, where the secondary layer comprises a functional material (760). During the extracting step (760), the functional material undergoes an endothermic chemical change at a temperature of at least about 220° C. at ambient pressure resulting in the release of steam.

In one embodiment, the method 700 includes the attaching step (720), the impeding step (740), and the step of producing steam, via a secondary layer, to facilitate a reduction in the partial pressure of oxygen proximal the fire-resistant panel (780). During the producing step (780), the secondary layer releases a gas upon attaining a temperature of about 100° C. when measured with a differential scanning calorimetry (DSC).

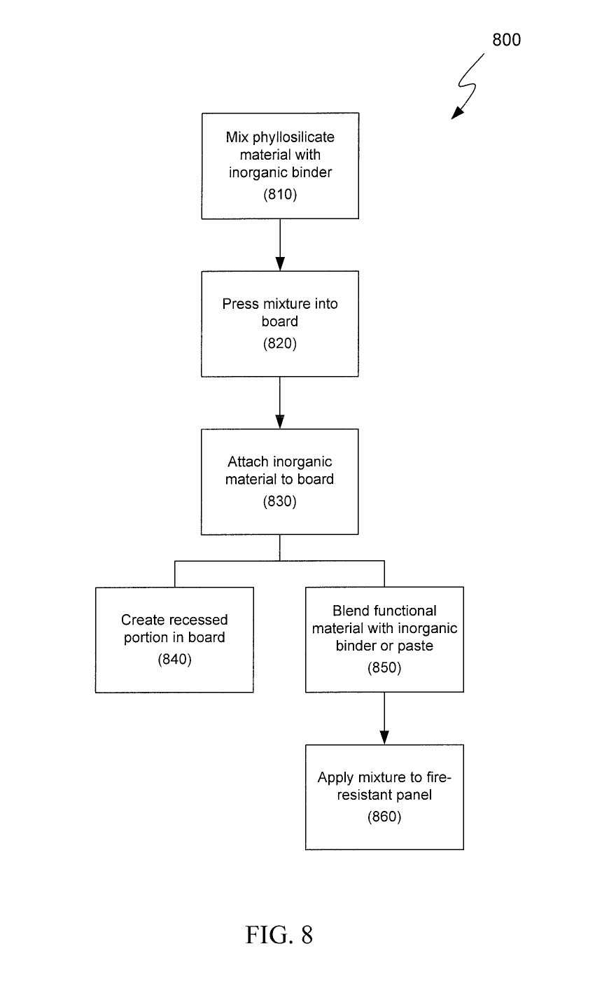

In another aspect, methods of producing a fire-resistant panel are provided. In one embodiment, and with reference to FIG. 8, the method 800 includes the steps of mixing a phyllosilicate material with an inorganic binder to form a mixture (810), pressing the mixture of the phyllosilicate material and inorganic binder into a board (820), and attaching an inorganic material to the board to form a fire-resistant panel (830).

In one embodiment, the method 800 includes the mixing step (810), the pressing step (820), the attaching step (830) and the step of creating a recessed portion in the board (840). In one embodiment, the method 800 includes mixing step (810), the pressing step (820), the attaching step (830) and the steps of blending a functional material with one of an inorganic binder or paste to form a mixture (850), and applying, after the blending step (850), the mixture to the fire-resistant panel (860).

### EXAMPLES

### Example 1

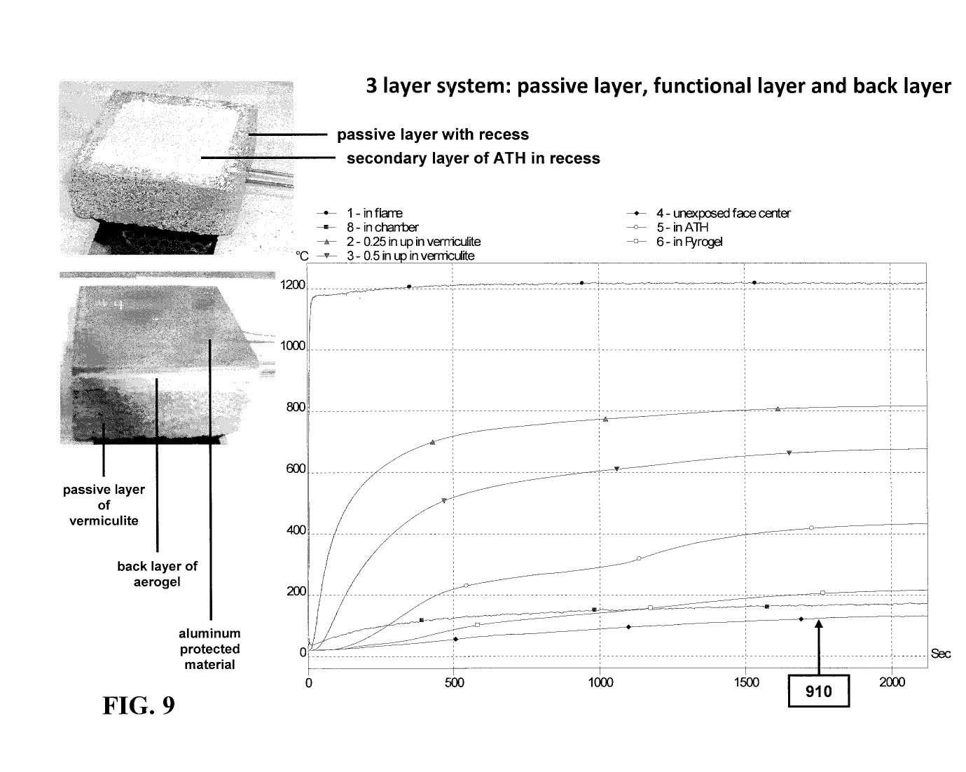

A panel similar to that of FIG. 2, as described above, is produced, as illustrated in FIG. 9. The panel includes a passive layer made of vermiculite, a secondary layer containing ATH (aluminum-tri-hydrate, Al(OH)₃) as a functional material, and a back layer of aerogel blanket. The passive layer has dimensions of about 2.5 in. (W)×2.5 in. (L)×1 in. (D). The passive layer includes a recessed portion having dimensions of about 2 in. (W)×2 in. (L)×0.187 in. (D). The recessed portion is filled with ATH powder. The back layer has dimensions of about 2.5 in. (W)×2.5 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, 0.5 inches from the bottom of the vermiculite, in the ATH, and in the aerogel blanket) and the temperature of the center of the unexposed face of the protected material aluminum, to name a few. A portion of the experimental setup is illustrated in FIG. 9.

FIG. 9 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 132° C. as shown on the y-axis and arrow 910. The average temperature of the unexposed face center of the aluminum during the 30 minute period of testing (i.e., from minute 5 to minute 35) is about 96° C.

### Example 2

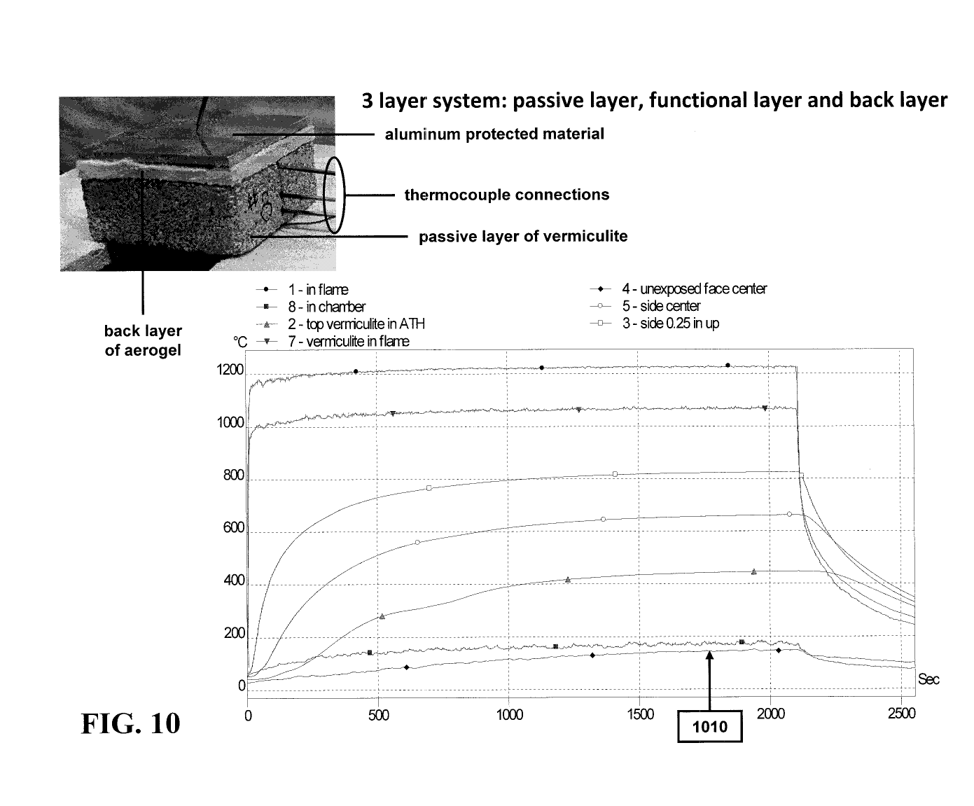

A panel similar to that of FIG. 2, as described above, is produced, as illustrated in FIG. 10. The panel includes a passive layer made of vermiculite, a secondary layer containing ATH (aluminum-tri-hydrate, Al(OH)₃) as a functional material, and a back layer of aerogel blanket. The passive layer has dimensions of about 2.5 in. (W)×2.5 in. (L)×1 in. (D). The passive layer includes a recessed portion having dimensions of about 2 in. (W)×2 in. (L)×0.02 in. (D). The recessed portion is partially filled with ATH powder (less powder than powder than in Example 1). The back layer has dimensions of about 2.5 in. (W)×2.5 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, side of the center of the vermiculite, recessed portion with ATH, and the vermiculite in the flame) and the temperature of the center of the unexposed face of the protected material aluminum, to name a few. A portion of the experimental setup is illustrated in FIG. 10.

FIG. 10 illustrates the fire resistance results of the panel. The temperature is measured for a period of roughly 2300 seconds (38 minutes) as shown on the x-axis. After a period of about 30 minutes (starting at 5 minutes), the unexposed face center of the aluminum reaches a temperature of not greater than about 152° C. as shown on the y-axis and arrow 1010. The average temperature of the unexposed face center of the aluminum during the 30 minute period of testing (i.e., from minute 5 to minute 35) is about 117° C.

### Example 3

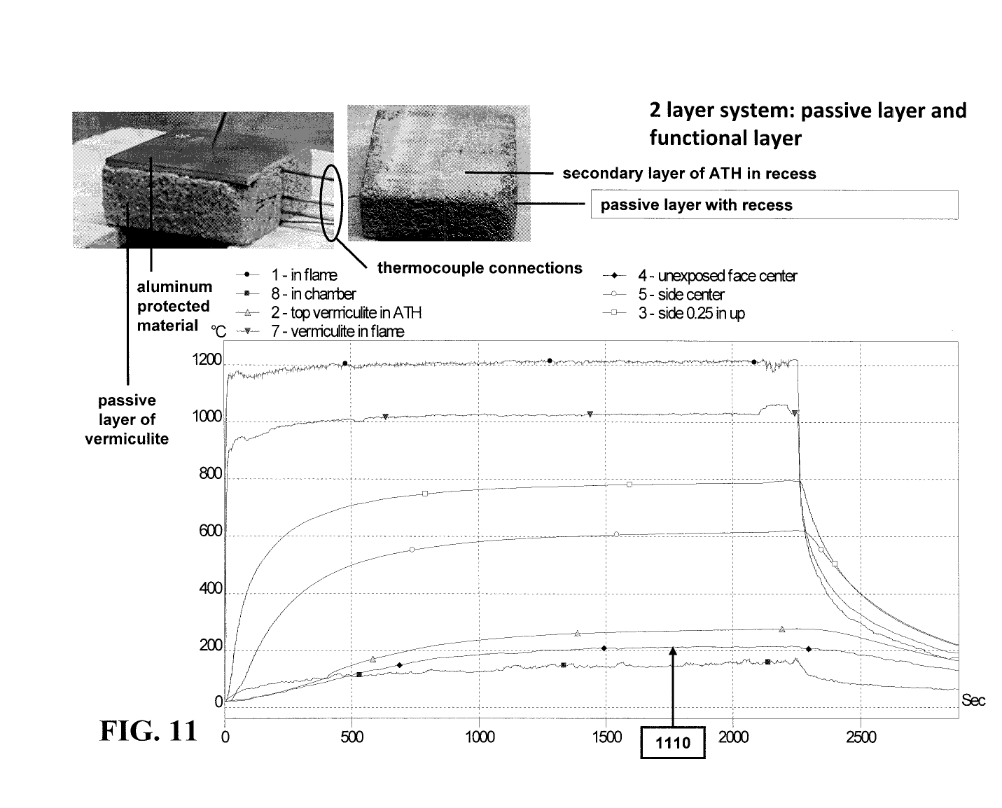

A panel similar to that of FIG. 1, as described above, except that the aerogel blanket back layer is replaced with a secondary layer filled with ATH, is produced, as illustrated in FIG. 11. The panel includes a passive layer made of vermiculite, and a secondary layer containing ATH (aluminum-tri-hydrate, Al(OH)₃) as a functional material. The passive layer has dimensions of about 2.5 in. (W)×2.5 in. (L)×1 in. (D). The passive layer includes a recessed portion having dimensions of about 2 in. (W)×2 in. (L)×0.02 in. (D). The recessed portion is filled with ATH powder.

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, side of the center of the vermiculite, recessed portion with ATH, and the vermiculite in the flame) and the temperature of the center of the unexposed face of the protected material aluminum, to name a few. A portion of the experimental setup is illustrated in FIG. 11.

FIG. 11 illustrates the fire resistance results of the panel. The temperature is measured for a period of roughly 2300 seconds (38 minutes) as shown on the x-axis. After a period of about 30 minutes (starting at 5 minutes), the unexposed face center of the aluminum reaches a temperature of not greater than about 216° C. as shown on the y-axis and arrow 1110. The average temperature of the unexposed face center of the aluminum during the 30 minute period of testing (i.e., from minute 5 to minute 35) is about 179° C.

### Example 4

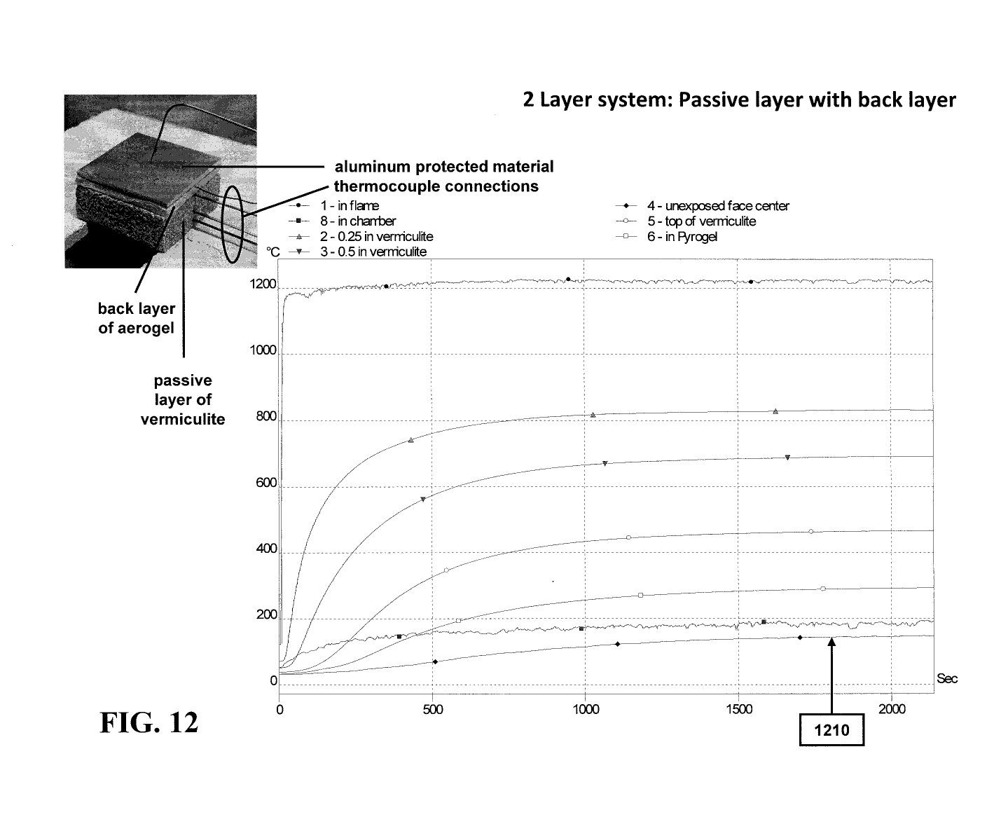

A panel similar to that of FIG. 1, as described above, is produced, as illustrated in FIG. 12. The panel includes a passive layer made of vermiculite, and a back layer of aerogel blanket. The passive layer has dimensions of about 2.5 in. (W)×2.5 in. (L)×1 in. (D). The back layer has dimensions of about 2.5 in. (W)×2.5 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, 0.5 inches from the bottom of the vermiculite, top of vermiculite, and in the aerogel blanket) and the temperature of the center of the unexposed face of the protected material aluminum, to name a few. A portion of the experimental setup is illustrated in FIG. 12.

FIG. 12 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 148° C. as shown on the y-axis and arrow 1210. The average temperature of the unexposed face center of the aluminum during the 30 minute period of testing (i.e., from minute 5 to minute 35) is about 116° C.

### Example 5

A panel similar to that of FIG. 3, as described above, is produced, as illustrated in FIG. 13. The panel includes a passive layer made of vermiculite, a spacer made of corrugated aluminum stock, and a back layer of aerogel. The passive layer has dimensions of about 2.5 in. (W)×2.5 in. (L)×0.25 in. (D). The spacer has dimensions of about 2 in. (W)×2.5 in. (L)×0.25 in. (D). The back layer has dimensions of about 2 in. (W)×2 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., in aerogel blanket, and in the air gap created by the spacer) and the temperature of the center of the unexposed face of the protected material aluminum, to name a few. A portion of the experimental setup is illustrated in FIG. 13.

FIG. 13 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 193° C. as shown on the y-axis and arrow 1310. The average temperature of the unexposed face center of the aluminum during the 30 minute period of testing (i.e., from minute 5 to minute 35) is about 142° C.

### Example 6

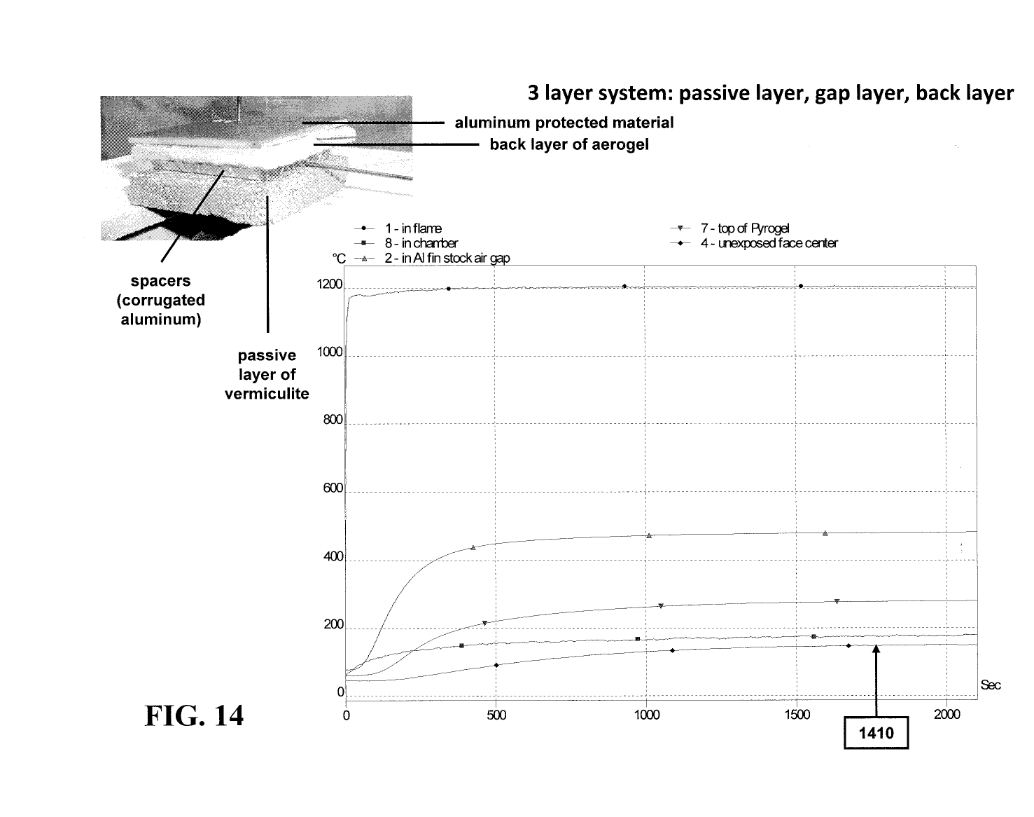

A panel similar to that of FIG. 3, as described above, is produced, as illustrated in FIG. 14. The panel includes a passive layer made of vermiculite, a spacer made of corrugated aluminum stock, and a back layer of aerogel blanket. The passive layer has dimensions of about 2.5 in. (W)×2.5 in. (L)×0.5 in. (D). The spacer has dimensions of about 2 in. (W)×2.5 in. (L)×0.25 in. (D). The back layer has dimensions of about 2.5 in. (W)×2.5 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., in aerogel blanket, and in the air gap created by the spacer) and the temperature of the center of the unexposed face of the protected material aluminum, to name a few. A portion of the experimental setup is illustrated in FIG. 14.

FIG. 14 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 151° C. as shown on the y-axis and arrow 1410. The average temperature of the unexposed face center of the aluminum during the 30 minute period of testing (i.e., from minute 5 to minute 35) is about 128° C.

### Example 7

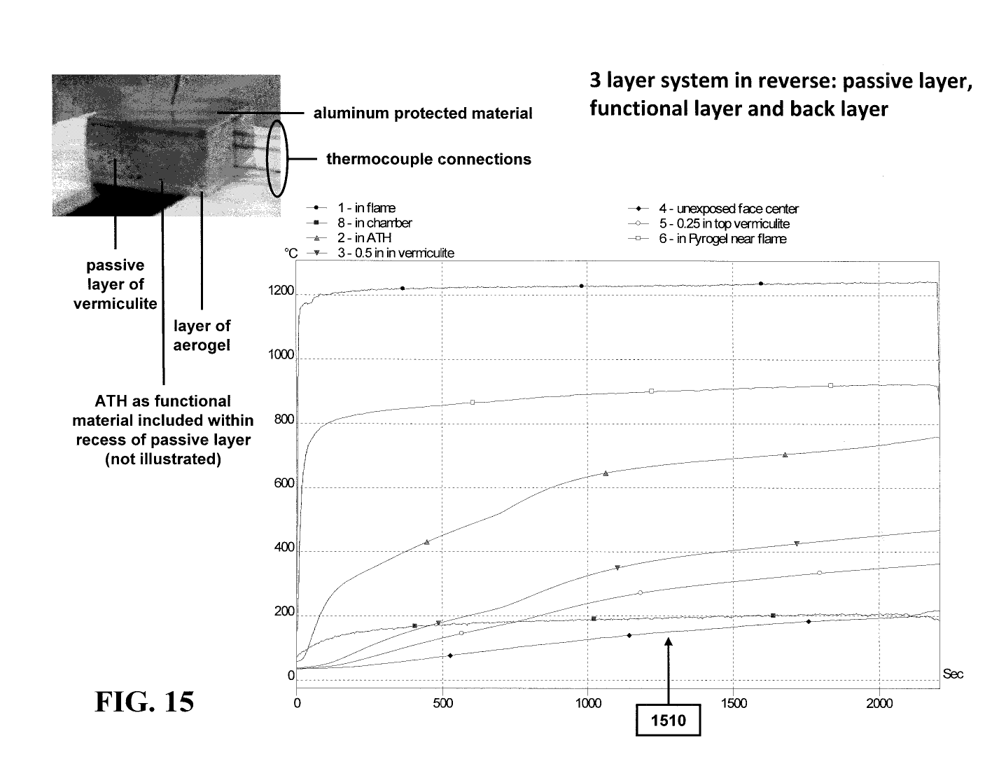

A panel similar to that of FIG. 2, as described above, except flipped (i.e., FIG. 2 upside down), is produced, as illustrated in FIG. 15. The panel includes a passive layer made of vermiculite, a secondary layer containing ATH (aluminum-tri-hydrate, Al(OH)₃) as a functional material, and a layer of aerogel blanket. The passive layer has dimensions of about 2.5 in. (W)×2.5 in. (L)×1 in. (D). The passive layer includes a recessed portion having dimensions of about 2 in. (W)×2 in. (L)×0.187 in. (D). The recessed portion is filled with ATH powder. The layer of aerogel blanket has dimensions of about 2 in. (W)×2 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, 0.5 inches from the bottom of the vermiculite, in the ATH, and in the aerogel blanket near the flame) and the temperature of the center of the unexposed face of the protected material aluminum, to name a few. A portion of the experimental setup is illustrated in FIG. 15.

FIG. 15 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 197° C. as shown on the y-axis and arrow 1510. The average temperature of the unexposed face center of the aluminum during the 30 minute period of testing (i.e., from minute 5 to minute 35) is about 137° C.

### Example 8

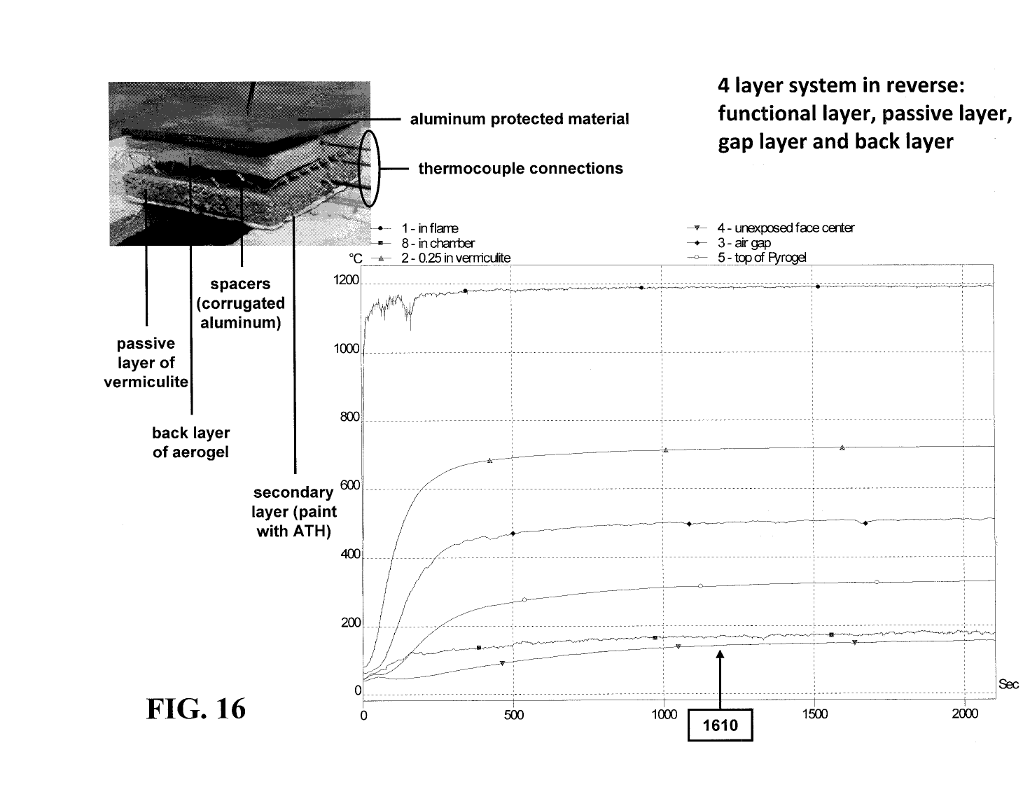

A panel similar to that of FIG. 4, as described above, is produced, as illustrated in FIG. 16. The panel includes a secondary layer containing a mixture of intumescent paint and ATH (aluminum-tri-hydrate, Al(OH)₃) as a functional material, a passive layer made of vermiculite, a spacer made of corrugated aluminum stock, and a back layer of aerogel blanket. The passive layer has dimensions of about 2.5 in. (W)×2.5 in. (L)×0.25 in. (D). The spacer has dimensions of about 2.5 in. (W)×3.25 in. (L)×0.25 in. (D). The back layer has dimensions of about 2.5 in. (W)×2.5 in. (L)×0.25 in. (D).

The panel is tested for fire resistance in accordance with UL-1709 (i.e., Rapid Rise Fire Test of Protection Materials for Structural Steel, Jul. 20, 2005) with a heat flux and maximum temperature curve higher than the UL 1709 curve. A protected material having dimensions of about 2.375 in. (W)×2.375 in. (L)×0.125 in. (D), and made of aluminum 6061-T6 aluminum alloy, is placed on top of the panel. A thermocouple measures the temperature of the panel at various places (e.g., 0.25 inches from the bottom of the vermiculite, top of aerogel blanket, and in the air gap created by the spacer) and the temperature of the center of the unexposed face of the protected material aluminum, to name a few. A portion of the experimental setup is illustrated in FIG. 16.

FIG. 16 illustrates the fire resistance results of the panel. The temperature is measured for a period of roughly 2100 seconds (35 minutes) as shown on the x-axis. After a period of about 30 minutes (starting at 5 minutes), the unexposed face center of the aluminum reaches a temperature of not greater than about 157° C. as shown on the y-axis and arrow 1610. The average temperature of the unexposed face center of the aluminum during the 30 minute period of testing (i.e., from minute 5 to minute 35) is about 133° C.

What is claimed is:

1. A system comprising:
(a) a fire-resistant panel, wherein the fire-resistant panel comprises:
(i) a passive layer comprising a phyllosilicate material;
(ii) a back layer comprising an inorganic material and coupled to the passive layer; and
(b) a protected material coupled to the fire-resistant panel.

2. The system of claim 1, wherein the fire-resistant panel has a flame spread index of not greater than about 25 when tested in accordance with ASTM E-84.

3. The system of claim 1, wherein the fire-resistant panel has a smoke developed index of not greater than about 50 when tested in accordance with ASTM E-84.

4. The system of claim 1, wherein the fire-resistant panel has a thickness of not greater than about 1.3 inches.

5. The system of claim 1, wherein the fire-resistant panel has a density of not greater than about 2 g/cm³.

6. The system of claim 1, wherein the fire-resistant panel further comprises:
a secondary layer comprising a functional material, wherein the functional material comprises one of a phase change material or an endothermic material.

7. The system of claim 6, wherein the phase change material is copper, and wherein the endothermic material is at least one of sodium bi-carbonate (NaHCO₃) and aluminium-tri-hydrate (ATH).

8. The system of claim 6, wherein the passive layer comprises a recessed portion, and wherein the functional material is at least partially located in the recessed portion.

9. The system of claim 1, wherein the fire-resistant panel further comprises:
a wrap comprising at least one of aluminum foil, metal foil, and amorphous silica fabric.

10. The system of claim 9, wherein the fire-resistant panel is encased within the wrap.

11. The system of claim 1, wherein the fire-resistant panel further comprises:
at least one spacer comprising at least one of aluminum finstock, aluminum expanded metal, and vermiculite, and wherein the at least one spacer is one of a protrusion of the passive layer, shims, dimples on the aluminum, blocks, or bars.

12. The system of claim 1, wherein the fire-resistant panel further comprises:
at least one cable configured to facilitate wiring between at least two fire-resistant panels; and
at least one electronic device configured to monitor at least one of security, temperatures, humidity, gas emissions, and acoustics of the protected material.

13. The system of claim 12, wherein the electronic device is a sensor.

14. The system of claim 12, wherein the at least one cable is located in the passive layer, and wherein the at least one electronic device is located in the passive layer.

15. The system of claim 1, wherein the protected material has a core, wherein the core of the protected material has an average temperature of not greater than 200° C. above its initial temperature when measured in accordance with section 3.5.3.3(b) of MIL-PRF-32161 or section 5.5.4 of MIL-STD-3020, and wherein the protected material has a thickness of not greater than 4 inches.

16. The system of claim 1, wherein the fire-resistant panel has a front face (F), wherein the protected material has an unexposed surface, and wherein the unexposed surface has an average temperature of not greater than 200° F. when the front face (F) of the of the fire-resistant panel is exposed to a temperature of 2000° F.+/−200° F. and a heat flux of at least 204+/−16 kW/m² for a minimum duration of 30 minutes when measured in accordance with UL 1709.

17. The system of claim 16, wherein the average temperature on the unexposed surface does not raise more than 250° F. (139° C.) above its initial temperature when tested in accordance with Appendix A of MIL-PRF-32161.

18. The system of claim 17, wherein the temperature of any one point on the unexposed surface does not raise more than 325° F. (181° C.) above its initial temperature when tested in accordance with Appendix A of MIL-PRF-32161.

19. A method comprising:
(a) attaching a fire-resistant panel to a protected material, wherein the fire-resistant panel comprises a passive layer comprising a phyllosilicate material and a back layer comprising an inorganic material, and wherein the protected material comprises an exposed surface, an unexposed surface, and a core; and
(b) impeding, in the presence of fire and via the passive layer and the back layer, heat transfer to the protected material;
wherein, during the impeding step, the core of the protected material has an average temperature of not greater than 200° C. above its initial temperature when measured in accordance with section 3.5.3.3(b) of MIL-PRF-32161 or section 5.5.4 of MIL-STD-3020.

20. An apparatus comprising a fire-resistant panel, wherein the fire-resistant panel comprises:
(a) a passive layer comprising a phyllosilicate material; and
(b) a back layer comprising an inorganic material and coupled to the passive layer.
